(19) United States
(12) Patent Application Publication
(10) Pub. No.: US 2003/0130454 A1
(43) Pub. Date: Jul. 10, 2003

(54) Process for producing amphipathic polymers

(75) Inventors: Masaaki Seya, Yokohama-shi (JP); Masayuki Tooyama, Yokohama-shi (JP)

Correspondence Address: FITCH EVEN TABIN AND FLANNERY, 120 SOUTH LA SALLE STREET, SUITE 1600, CHICAGO, IL, 60603-3406, US

(73) Assignee: Mitsubishi Rayon Co., Ltd.

(21) Appl. No.: 10/289,206

(22) Filed: Nov. 7, 2002

(30) Foreign Application Priority Data
Nov. 7, 2001 (JP) 2001-342144
Nov. 28, 2001 (JP) 2001-363225
Nov. 28, 2001 (JP) 2001-363226

(51) Int. Cl. C08F 2/00

(52) U.S. Cl. 526/207; 526/303.1

(57) ABSTRACT

A process for producing polymers which comprises polymerizing an amphipathic monomer or copolymerizing an amphipathic monomer and another monomer which is copolymerizable therewith, wherein a polymerization solvent, a nonionic chain transfer agent and 1,1′-azobis(cyclohexane-1-carbonitrile) as a polymerization initiator are used together with the monomer. It is thereby possible to produce polymers with high hydrate formation and dissociation-controlling performance, and to produce polymers of low molecular weight with low residual monomer contents using the same amounts of polymerization initiators.

### BACKGROUND OF THE INVENTION

1. Field of the Invention

The present invention relates to a process for producing amphipathic polymers. According to the process of the invention it is possible to obtain polymers useful as gas hydrate formation and dissociation-controlling agents and to obtain polymers of low molecular weight with low monomer contents under conditions using equal amounts of polymerization initiators.

2. Description of the Related Art

Polymers comprising amphipathic monomer units as components hold promise for applications in various fields including medicine, pharmacy, agricultural chemicals, actuators, cosmetics, detergents, hydrate production inhibitors and the like. They are expected to be especially useful as formation and dissociation-controlling agents for gas hydrates which are produced when aqueous media dissolving various gas molecules, including hydrocarbons such as methane and ethane or carbon dioxide gas, are kept at a specific temperature and pressure.

For example, formation of gas hydrates during mining and shipping of crude oil and natural gas causes clogging of pipelines, creating a major obstacle to safe and continuous operation, and therefore additives which inhibit formation of gas hydrates are in demand. Techniques for inhibiting formation of gas hydrates are desired because formation of gas hydrates in the drilling mud during drilling of crude oil and the like blocks circulation of the mud, in some cases making it impossible to accomplish drilling, but a simultaneous effect of inhibiting dissociation of gas hydrates is also desired because the presence of gas hydrates in the stratum during drilling poses a risk due to increasing pressure by dissociation.

On the other hand, gas hydrates are also known to be naturally present under high-pressure, low-temperature conditions, and methods are desired for safely extracting natural methane hydrate in a stable state. LNG (Liquefied Natural Gas) methods are usually employed for transport and storage of fuel gas and especially methane gas, but because of the high construction and building costs for LNG bases and LNG transport tankers, it is not suitable for small-scale gas fields and can even be an impediment to development of small-scale gas fields. The use of gas hydrates for transport and storage of natural gas is considered to be more cost effective than LNG in the case of small-scale gas fields, and the cost can be further reduced by stabilizing the storage under milder conditions by using, for example, gas hydrate production inhibitors.

Thus, it is desirable to inhibit or delay formation of gas hydrates during pipeline transport of water-containing drilled gas such as methane, while it is also desirable to inhibit or delay gas hydrate formation, and prevent its dissociation, during drilling of oil fields and the like. Furthermore, in order to accelerate and stabilize formation of extracted gas hydrates during their shipping and storage, to accelerate dissociation and/or inhibit or stabilize formation of gas hydrates during extraction of the gas hydrates from the sea floor or ground floor and to stabilize or delay dissociation of gases such as methane when their gas hydrates are utilized as storage means, gas hydrate formation and dissociation-controlling agents must satisfactorily exhibit the following apparently contradictory aspects of performance.

(1) They must inhibit formation of gas hydrates (equilibrium formation inhibition) or delay their formation rate (kinetic formation inhibition, or formation delay).

(2) They must accelerate formation of gas hydrates (equilibrium stabilization, or kinetic formation acceleration) or delay the dissociation rate of formed gas hydrates (kinetic stabilization, or dissociation delay).

Formation and dissociation-controlling agents exhibiting such apparently contradictory effects are proposed in Japanese Unexamined Patent Publication No. 2000-273475, Japanese Unexamined Patent Publication No. 2001-164274, Japanese Unexamined Patent Publication No. 2001-234182, Japanese Unexamined Patent Publication No. 2001-139965, Japanese Unexamined Patent Publication No. 2001-139966, Japanese Unexamined Patent Publication No. 2001-164276 and Japanese Unexamined Patent Publication No. 2001-187890. Also, hydrate formation-inhibiting polymers are proposed in WO98/53007, WO97/07320 and WO96/41786.

These polymers are usually produced by radical polymerization. Common methods are known for obtaining low molecular weight water-soluble polymers using mercaptanes as chain transfer agents.

For example, Japanese Unexamined Patent Publication No. 2000-230008 proposes a method of polymerizing N-isopropyl (meth)acrylamide in an aqueous solvent system using a water-soluble azo initiator at a temperature below the lower critical consolute temperature. Japanese Unexamined Patent Publication No. 2000-297105 proposes a method of polymerizing an amphipathic monomer in an aqueous solvent with a water-soluble polymerization initiator.

Also, Japanese Unexamined Patent Publication No. 2000-119343 proposes a method of polymerizing a composition comprising N-isopropyl (meth)acrylamide monomer in the presence of cysteamine.

Japanese Unexamined Patent Publication No. 2000-186121 proposes a method of improving the clouding point of polymers by copolymerizing a monomer which by itself has a clouding point and a monomer with a dissociating group, in the presence of a mercaptane or the like with a dissociating group. The examples describe a polymerization process in which the monomer solution and a chain transfer agent are charged into a polymerization reactor while the monomer solution, chain transfer agent and initiator are added dropwise.

WO01/66602 discloses a method for polymer production characterized by separately charging a monomer in a first solvent and a polymerization initiator in a second solvent different from the first solvent and almost completely removing the second solvent from the polymer after completion of the polymerization reaction, and it is stated that high hydrate inhibitor performance is exhibited by the polymer obtained by this method.

Japanese Unexamined Patent Publication No. 2000-186121 discloses an example of polymerizing N-isopropylacrylamide in the presence of mercaptopropionic acid, using 1,1′-azobis(cyclohexane-1-carbonitrile), as a method of improving the clouding point of a polymer. However, the polymerization process described in this publication requires the use of a mercaptane and/or sulfide having a dissociating group in the molecule, and this reduces the hydrate formation and dissociation-controlling performance. Thus, it does not offer the improvement in performance that is obtained by the polymer production process of the present invention, nor does it predict the effect of the process of the present invention, by the combination of an amphipathic monomer, a nonionic initiator and a nonionic chain transfer agent.

The following processes have been disclosed as processes for production of polymers with high gas hydrate formation and dissociation-controlling effects. For example, Japanese Unexamined Patent Publication No. 2001-164274 discloses solution polymerization in a system containing N-isopropylmethacrylamide using 2,2′-azobisisobutyronitrile as the initiator. Also, Japanese Unexamined Patent Publication No. 2001-139965, Japanese Unexamined Patent Publication No. 2001-139966 and Japanese Unexamined Patent Publication No. 2001-164276 each disclose solution polymerization in a system containing N-isopropylmethacrylamide using 2,2′-azobis(2-methylbutyronitrile) as the initiator. Japanese Unexamined Patent Publication No. 2001-234182 discloses the use of potassium persulfate, 2,2′-azobis(2-amidinopropane) dihydrochloride and 2,2′-azobis[2-(2-imidazolin-2-yl)propane] dihydrochloride as initiators in a system containing N-isopropylmethacrylamide.

Incidentally, WO98/53007 and WO97/07320 do not mention radical initiator species. W096/41786 discloses a process using ammonium persulfate and 2,2′-azobisisobutyronitrile as initiators, but makes no reference to the effect of the initiator species.

Polymerization of isopropylmethacrylamide monomers is generally accomplished using a polymerization initiator, with a solvent system dissolving the monomer and the polymerization initiator. In the case of an isopropylmethyacrylamide-based polymer, for example, which has a clouding point in water, its polymerization at a high temperature above the clouding point results in precipitation of the polymer as polymerization progresses, thus hampering further polymerization. The polymerization is therefore preferably carried out in an organic solvent, but because of the high cost of removing the organic solvent it is preferred to use a solvent which may be suitably included for use.

Incidentally, isopropylmethacrylamide-based polymers are known as polymers exhibiting very high hydrate-inhibiting effects, as explained in WO96/41786, for example. For production of such polymers, therefore, there is demand for an efficient polymerization process which leaves a low amount of residual monomer, using a solvent that can be added in the pipeline without removal for use.

### BRIEF SUMMARY OF THE INVENTION

It is an object of the present invention to provide a process for producing polymers with excellent gas hydrate formation and dissociation-controlling effects. It is a particular object of the invention to provide a process which allows production of polymers of low molecular weight with low residual monomer contents using equal amounts of polymerization initiators.

The present inventors have completed the present invention upon finding that polymers with such excellent performance can be obtained through a modification in a process for polymerization of amphipathic monomers.

Specifically, the present invention provides a process for producing polymers which comprises polymerizing an amphipathic monomer or copolymerizing an amphipathic monomer and another monomer which is copolymerizable therewith, wherein a polymerization solvent, a nonionic chain transfer agent and 1,1′-azobis(cyclohexane-1-carbonitrile) as a polymerization initiator are used together with the monomer.

### BRIEF DESCRIPTION OF THE DRAWINGS

FIG. 1 is a schematic diagram of an apparatus for evaluation of gas hydrate formation and dissociation-controlling performance.

FIG. 2 is a schematic diagram of a measuring apparatus for THF hydrate formation-inhibiting performance.

### DETAILED DESCRIPTION OF THE INVENTION

Amphipathic Monomer

For the purpose of the invention, an amphipathic monomer is one having both a hydrophilic group and a hydrophobic group, and having a polymerizable group. For example, it is “a monomer soluble in water and soluble in solvents that are not miscible with water (commonly referred to as non-aqueous solvents)”, which is also polymerizable. According to the invention, however, monomers which are not definitely amphipathic alone but are amphipathic as polymers will also be referred to as “amphipathic monomers” for convenience.

As examples of amphipathic monomers there may be mentioned N-ethyl (meth)acrylamide, N-cyclopropyl (meth)acrylamide, N-isopropyl (meth)acrylamide, N-n-propyl (meth)acrylamide, N-methyl-N-ethyl (meth)acrylamide, N,N-diethyl (meth)acrylamide, N-methyl-N-isopropyl (meth)acrylamide, N-methyl-N-n-propyl (meth)acrylamide, N-(meth)acryloylpyrrolidine, N-(meth)acryloylpiperidine, N-2-ethoxyethyl (meth)acrylamide, N-3-methoxypropyl (meth)acrylamide, N-3-ethoxypropyl (meth)acrylamide, N-3-isopropoxypropyl (meth)acrylamide, N-3-(2-methoxyethoxy)propyl (meth)acrylamide, N-3-(2-methoxyethoxy)propyl (meth)acrylamide, N-tetrahydrofurfuryl (meth)acrylamide, N-1-methyl-2-methoxyethyl (meth)acrylamide, N-1-methoxymethylpropyl (meth)acrylamide, N-(2,2-dimethoxyethyl)-N-(meth)acrylamide, N-(1,3-dioxolan-2-ylmethyl)-N-(meth)acrylamide, N-2-methoxyethyl-N-(meth)acrylamide, N-2-methoxyethyl-N-n-propyl (meth)acrylamide, N-2-methoxyethyl-N-isopropyl (meth)acrylamide, N,N-di(2-methoxyethyl)(meth)acrylamide, N-vinylpyrrolidone, N-vinylcaprolactam, N-isopropenylpyrrolidone, N-isopropenylcaprolactam and the like.

Among these, N-ethylmethacrylamide, N-cyclopropylmethacrylamide, N-isopropylmethacrylamide, N-n-propylmethacrylamide, N-methyl-N-ethylmethacrylamide, N,N-diethylmethacrylamide, N-methyl-N-isopropylmethacrylamide, N-methyl-N-n-propylmethacrylamide, N-vinylpyrrolidone, N-vinylcaprolactam are preferred. N-isopropylmethacrylamide is especially preferred because it produces polymers with very high hydrate formation and dissociation-controlling effects.

Polymer

A polymer produced by the process of the invention is either a simple polymer of an amphipathic monomer or a copolymer of an amphipathic monomer and another monomer that is copolymerizable with the amphipathic monomer, where the copolymer preferably comprises at least 50 mole percent of the amphipathic monomer component.

As examples of monomers that are copolymerizable with amphipathic monomers there may be mentioned hydrophilic monomers such as N-(meth)acrylamide, N-methyl (meth)acrylamide, N,N-dimethyl (meth)acrylamide, N-(meth)acryloylmethylhomopiperazine, N-(meth)acryloylmethylpiperazine, N-2-hydroxyethyl-N-(meth)acrylamide, N-3-hydroxypropyl (meth)acrylamide, N-2-methoxyethyl (meth)acrylamide, N-3-morpholinopropyl (meth)acrylamide, N-(meth)acryloylmorpholine, N-2-methoxyethyl-N-methyl (meth)acrylamide, (meth)acrylic acid and its salts, 2-hydroxyethyl (meth)acrylate, ethyleneglycol (meth)acrylate, diethyleneglycol (meth)acrylate, polyethyleneglycol (meth)acrylate, propyleneglycol (meth)acrylate, butanediol (meth)acrylate, trimethylolpropane (meth)acrylate, dimethylaminoethyl (meth)acrylate, dimethylamidopropyl (meth)acrylamide, vinyl acetate, vinyl propionate, methyl vinyl ether, ethyl vinyl ether, 2-vinyl-2-oxazoline, 2-vinyl-4-methyl-2-oxazoline, 2-isopropyl-2-oxazoline, N-vinylacetamide, N-vinyl-N-methylacetamide, N-vinylformamide, N-vinyl-N-methylformamide, N-vinyl-N-n-propylpropionamide, N-vinyl-N-methylpropionamide, N-vinyl-N-i-propylpropionamide, N-vinylpropionamide, vinyl butyrate, N-allylamide, maleic acid, vinylimidazole, dimethylaminoethyl (meth)acrylate methylchloride, dimethylaminoethyl (meth)acrylate benzylchloride, 2-(meth)acrylamido-2-methylpropanesulfonic acid and its salts, (meth)acrylamide methanesulfonic acid and its salts, (meth)acrylamide ethanesulfonic acid and its salts, 2-(meth)acrylamido-n-butanesulfonic acid and its salts, glycosyloxyethyl acrylate, glycosyloxyethyl methacrylate, glycosyloxyethyl-α-ethyl acrylate, glycosyloxyethyl-β-methyl acrylate, glycosyloxyethyl-β,β-dimethyl acrylate, glycosyloxyethyl-β-ethyl acrylate, glycosyloxyethyl-β,β-diethyl acrylate, ethylene glycol, propylene glycol and the like. As examples of hydrophobic monomers there may be mentioned alkyl (meth)acrylates, alkyl (meth)acrylamides, heterocycle (meth)acrylates, heterocycle (meth)acrylamides, and vinylbenzenes optionally having lower alkyl groups or halogen atoms as substituents on the benzene rings. The copolymerizable monomers used are preferably nonionic.

Molecular Weight of Polymer

The molecular weight of a polymer obtained according to the invention is preferably in the range of 500-10,000 in terms of mass-average molecular weight. A smaller mass-average molecular weight results in greater mobility of the polymer molecules in water, thereby enhancing the formation and dissociation-controlling performance for gas hydrates, while a larger molecular weight increases the proportion of formation and dissociation control performance-exhibiting sites in the polymer.

The mass-average molecular weight of a polymer obtained according to the invention may be determined by a publicly known method such as described, for example, in Mori et al., Anal. Chem., 55, 2414-2416(1983).

Initiator

According to the invention, 1,1′-azobis(cyclohexane-1-carbonitrile) is used as the polymerization initiator. This produces a polymer with high gas hydrate formation and dissociation-controlling performance.

The 1,1′-azobis(cyclohexane-1-carbonitrile) may also be used with another polymerization initiator. For example, azo initiators, peroxides and the like may be used in combination therewith.

As azo initiators there may be mentioned nonionic ones such as 2,2′-azobis(2-methylbutyronitrile), 2,2′-azobis(4-methoxy-2,4-dimethylvaleronitrile), 2,2′-azobis(2,4-dimethylvaleronitrile), 2,2′-azobisisobutyronitrile, 2-phenylazo-4-methoxy-2,4-dimethylvaleronitrile, 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl] propionamide}, 2,2′-azobis[2-methyl-N-(2-hydroxyethyl) propionamide], 2,2′-azobis(2-methylpropionamide) dihydrate, 2,2′-azobis(2,4,4-trimethylpentane), dimethyl-2,2′-azobis(2-methylpropionate), 2,2′-azobis[2-(hydroxymethyl)propionitrile] and 2-cyano-2-propylazoformamide. There may also be mentioned ionic ones such as 4,4′-azobis(4-cyanovaleric acid), 2,2′-azobis[N-(2-carboxyethyl)-2-methylpropionamidine] dihydrate, 2,2′-azobis[2-(5-methyl-2-imidazolin-2-yl)propane] dihydrochloride, 2,2′-azobis[2-(2-imidazolin-2-yl)propane] dihydrochloride, 2,2′-azobis[2-(2-imidazolin-2-yl)propane] disulfate dihydrate, 2,2′-azobis[2-(3,4,5,6-tetrahydropyrimidin-2-yl)propane] dihydrochloride, 2,2′-azobis{2-[1-(2-hydroxyethyl)-2-imidazolin-2-yl]propane} dihydrochloride, 2,2′-azobis(2-amidinopropane) dihydrochloride and 2,2′-azobis{2-[N-(2-carboxyethyl)amidino]propane}.

As peroxides there may be mentioned isobutyl peroxide, tert-butyl peroxide, α,α-bis(neodecanoylperoxy) diisopropylbenzene, cumylperoxy neodecanoate, di-n-propylperoxy dicarbonate, diisopropylperoxy dicarbonate, 1,1,3,3-tetramethylbutylperoxy neodecanoate, bis(4-t-butylcyclohexyl)peroxy dicarbonate, 1-cyclohexyl-1-methylethylperoxy neodecanoate, di-2-ethoxyethylperoxy dicarbonate, di(2-ethylhexylperoxy) dicarbonate, t-hexylperoxy neodecanoate, dimethoxybutylperoxy dicarbonate, di(3-methyl-3-methoxybutylperoxy) dicarbonate, t-butylperoxy neodecanoate, t-hexylperoxy pivalate, t-butylperoxy pivalate, 3,5,5-trimethylhexanoyl peroxide, octanoyl peroxide, lauroyl peroxide, stearoyl peroxide, 1,1,3,3-tetramethylbutylperoxy-2-ethylhexanoate, succinic peroxide, 2,5-dimethyl-2,5-di(2-ethylhexanoylperoxy)hexane, 1-cyclohexyl-1-methylethylperoxy-2-ethylhexanoate, t-hexylperoxy-2-ethylhexanoate, t-butylperoxy-2-ethylhexanoate, m-toluylbenzoyl peroxide, benzoyl peroxide, t-butylperoxy isobutyrate, di-t-butylperoxy-2-methylcyclohexane, 1,1-bis(t-hexylperoxy)-3,5,5-trimethylcyclohexane, 1,1-bis(t-hexylperoxy)cyclohexane, 1,1-bis(t-butylperoxy)-3,5,5-trimethylcyclohexane, hydrogen peroxide and the like.

Redox initiators and photoinitiators may also be used in combination therewith.

Among these, nonionic initiators, and especially nonionic azo initiators, are preferred from the standpoint of improving the gas hydrate formation and dissociation-controlling performance of the polymers produced using the initiators. As a particularly preferred initiator there may be mentioned 2,2′-azobis(2-methylbutyronitrile).

Chain Transfer Agent

As examples of nonionic chain transfer agents to be used for the polymerization there may be mentioned alkylmercaptans such as n-butylmercaptan and n-octylmercaptan, formaldehyde, acetaldehyde, propionaldehyde, n-butyraldehyde, isobutyraldehyde, diacetyl sulfide, ethyl thioglycolate, 2-mercaptoethanol, 1,3-mercaptopropanol, 3-mercapto-1,2-propanediol, 1,4-mercaptobutanol, diethanol sulfide, thiodiglycol, ethylthioethanol, thiourea, allyl alcohol and the like. Among these, alkylmercaptans, n-butyraldehyde, isobutyraldehyde, diacetyl sulfide, ethyl thioglycolate, 2-mercaptoethanol, 1,3-mercaptopropanol, 3-mercapto-1,2-propanediol are preferred. Mercaptanes with hydroxyl groups, such as 2-mercaptoethanol, 1,3-mercaptopropanol and 3-mercapto-1,2-propanediol are preferred because their resulting polymers exhibit higher gas hydrate production-inhibiting performance, while 3-mercapto-1,2-propanediol is particularly preferred.

Polymerization Solvent

The solvent used for the polymerization may be appropriately selected depending on the polymerization method, but in most cases water, alcohols, ketones, esters, amides, nitrites and the like will be used. As examples of organic solvents there may be mentioned one or more selected from the group consisting of alcohols such as methanol, ethanol, butanol, ethylene glycol, propylene glycol, 1,3-propanediol and glycerol, ketones such as acetone, methyl ethyl ketone and methyl butyl ketone, ethers such as diethyl ether, 1,4-dioxane, tetrahydrofuran, 2-ethoxyethanol, 2-methoxyethanol and 2-(2-methoxyethoxyethanol), esters such as ethyl acetate, butyl acetate and methyl propionate, amides such as (methyl)pyrrolidone and nitrites such as acetonitrile. Preferred are alcohols such as methanol, ethanol, butanol, ethylene glycol, propylene glycol, 1,3-propanediol and glycerol, with ethylene glycol being particularly preferred, and any two or more of these may also be used in combination. For example, mixture of methanol with a small amount of another solvent is preferred as a combined solvent because this can prevent adhesion of N-isopropylmethacrylamide sublimates onto the polymerization boiler walls or the condenser during polymerization, and can by itself exhibit gas hydrate formation and dissociation-controlling performance.

Moisture

For the process of the invention, a process for production of N-isopropylmethacrylamide polymers is preferably solution polymerization using a mixed solvent of the polymerization solvent and water. The solvent mixed with water is preferably ethylene glycol, and it may be further mixed with another solvent. Admixture of a small amount of methanol is preferred for the reason explained above. The lower limit for the water content is preferably 2 mass % or greater, and preferably 10 mass % or greater. The upper limit is preferably no greater than 50 mass % and more preferably no greater than 30 mass %. These limiting ranges are preferred from the standpoint of reducing the residual monomer amount. The water content is measured by the Carl-Fischer method. The water content (mass %) according to the invention is expressed by the following formula.

Water content (mass %)=moisture mass/(polymerization solution mass−effective polymer mass)×100

Polymer Production Process

As methods for the polymer production process of the invention there may be mentioned methods such as aqueous solution polymerization, solution polymerization using organic solvents, precipitation polymerization, emulsion polymerization, reverse-phase emulsion polymerization, soap-free polymerization, suspension polymerization, reverse-phase suspension polymerization, and the like. Among these polymerization methods, solution polymerization, precipitation polymerization, emulsion polymerization and soap-free polymerization are preferred, with solution polymerization being particularly preferred.

For the polymerization, the method employed is preferably one in which the monomer is charged at once into the boiler and heated and the initiator is added, in order to achieve a higher polymerization rate. After the initiator has been added at the start of polymerization, the heat of polymerization increases the internal temperature above the external temperature. Heat is then gradually removed until the external and internal temperatures are equal. In this polymerization method, the polymerization initiator is preferably further added after the polymerization peak temperature has been reached, in order to further increase the polymerization rate.

There are no particular restrictions on the timing of addition of the chain transfer agent, but at least a portion is added during charging of the monomer in order to obtain a polymer with high gas hydrate formation and dissociation-controlling performance and in order to inhibit production of high molecular weight components due to polymerization during the charging and during temperature increase. Also, a portion of a nonionic chain transfer agent is preferably added, after the temperature peak by heat of polymerization has been reached, in order to reduce the residual monomer amount and inhibit production of high molecular weight components.

The lower limit for the polymerization temperature is preferably 30° C. or higher, and more preferably 60° C. or higher. The upper limit is preferably no higher than 170° C. and more preferably no higher than 130° C. A lower polymerization temperature is preferred from the standpoint of suppressing side reactions such as decomposition of the polymer, while a higher polymerization temperature is preferred from the standpoint of speeding polymerization.

Dropwise Polymerization

The process for producing polymers according to the invention is most preferably a process wherein polymerization is conducted while adding the monomer, initiator and nonionic chain transfer agent dropwise to the polymerization solvent.

Such a process of polymerization with dropwise addition of the monomer, initiator and nonionic chain transfer agent is a preferred polymerization process from the standpoint of efficiently producing a polymer with a molecular weight and composition in ranges that give excellent performance, since it can prevent run-away polymerization caused by heat of polymerization, etc. and can produce a polymer with a narrow molecular weight distribution.

This process produces a polymer with particularly high hydrate production-inhibiting performance.

The dropwise addition may be accomplished by first mixing the monomer, initiator and nonionic chain transfer agent and adding the mixture dropwise to the polymerization system, by adding each separately, or by adding dropwise a mixture of any two and then adding the other component separately.

For the dropwise addition, at least one selected from the group consisting of the aforementioned polymerization solvents may be used as the dropping solvent. Alcohols are particularly preferred, and especially methanol, butanol and ethylene glycol, with ethylene glycol being most preferred. The solvent used may also contain water.

These solvents may be left in the polymerization system, or they may be optionally removed during the polymerization. A process in which the solvent is removed during the polymerization is preferred from the standpoint of raising the monomer polymerization rate and increasing the polymerization yield per polymerizer.

The time required for the dropwise addition will differ depending on the initiator system used, but the lower limit is preferably at least 15 minutes and more preferably at least 30 minutes, while the upper limit is preferably no greater than 12 hours and more preferably no greater than 6 hours. A shorter polymerization time is preferred from the standpoint of increasing the polymer product yield per unit time, whereas a longer polymerization time is preferred from the standpoint of obtaining a polymer with a more narrow molecular weight distribution.

The temperature for the polymerization will also differ depending on the initiator system used, but the lower limit is preferably 40° C. or higher, more preferably 60° C. or higher and even more preferably 80° C. or higher. The upper limit is preferably no higher than 150° C., more preferably no higher than 130° C. and even more preferably no higher than 120° C. A lower polymerization temperature is preferred from the standpoint of suppressing side reactions such as decomposition of the polymer, whereas a higher temperature is preferred from the standpoint of a more rapid progress of the polymerization.

Proportion of Initiator and Chain Transfer Agent for Dropwise Polymerization

According to the process of the invention, the nonionic chain transfer agent to be dropped is preferably adjusted to a molar ratio of 3-20 with respect to the polymerization initiator for dropwise polymerization, in order to obtain a polymer with high gas hydrate formation and dissociation-controlling performance.

Such dropwise polymerization can produce a polymer with a narrow molecular weight distribution, with the resulting polymer exhibiting very high gas hydrate formation and dissociation-controlling performance within the specific mass-average molecular weight range of 1200-3000.

Purpose and Method of Use

A polymer obtained by the process of the invention is particularly useful as a hydrate formation and dissociation-controlling agent. The polymer may be added to a gas hydrate formation system for use as a gas hydrate formation and dissociation-controlling agent. It may also be used as a gas hydrate formation and dissociation-controlling agent in combination with other formation and dissociation-controlling agents. As examples of other suitable formation and dissociation-controlling agents there may be mentioned hydrophilic polymers, ethylene glycol, triethylene glycol, methanol, ethanol, acetone and the like, among which ethylene glycol and hydrophilic polymers are preferred. When another formation and dissociation-controlling agent is used in combination therewith, the proportion of the polymer obtained according to the invention will be preferably 1-80 mass %, more preferably 20-60 mass % and even more preferably 30-60 mass % with respect to the total amount of the formation and dissociation-controlling agents.

Here, a “gas hydrate formation system” is a system in which a gas hydrate-forming substance is dissolved in an aqueous solvent as described, for example, on pages 1-9 of J. Long, A. Lederhos, A. Sum, R. Christiansen, E. D. Sloan; Prep. 73rd Ann. GPA Conv., 1994. In this type of system, the gas hydrate precipitates as crystals under specific pressure and temperature conditions.

As gas hydrate-forming substances there may be mentioned gases such as carbon dioxide, nitrogen, oxygen, hydrogen sulfide, argon, xenon, methane, ethane or propane, and liquids such as tetrahydrofuran.

As examples of gas hydrate formation systems there may be mentioned a system wherein an aqueous phase with a gas such as ethane or propane dissolved in an aqueous solvent such as water or brine is suspended or dispersed in an oily phase such as liquefied gas or crude oil in a natural gas well or oil well, or a system wherein a gas phase such as natural gas is present in an aqueous phase.

There are no particular restrictions on the method of adding the gas hydrate formation and dissociation-controlling agent polymer obtained according to the invention to the gas hydrate formation system, but it is preferably added after dissolution in water and/or a water-miscible solvent. A water-miscible solvent is a solvent that mixes with water in any desired proportion, and examples thereof include methanol, ethanol, acetone and ethylene glycol.

The lower limit for the amount of addition of the gas hydrate formation and dissociation-controlling agent is preferably at least 0.01 part by mass and more preferably at least 1 part by mass with respect to 100 parts by mass of the free water in the gas hydrate formation system. The upper limit is preferably no greater than 100 parts by mass and more preferably no greater than 50 parts by mass. A greater amount of the gas hydrate formation and dissociation-controlling agent improves the gas hydrate stabilizing effect, while a lesser amount lowers the viscosity of the system, thereby improving the fluidity.

When a polymer obtained according to the invention is used as a gas hydrate formation and dissociation-controlling agent, various additives such as rust preventives, lubricants, dispersing agents, scaling inhibitors, corrosion inhibitors and the like may be used in combination therewith.

The present invention will now be explained in greater detail through examples, with the understanding that they are in no way limitative on the invention.

Measurement of Effective Portion of Obtained Polymer Solution

The amount of ethylene glycol, methanol and residual N-isopropylmethacrylamide monomer in the polymerization solution was measured by gas chromatography, and the remainder was considered the effective portion.

Polymer Molecular Weight Measuring Apparatus

The polymer molecular weight was measured with the following apparatus and measuring conditions.

Apparatus: 8010 System (RI detector) by Toso Corp.

Column: Shodex GPC KD-806M (8×300 mm) Ultrahydrogel 120 6μ(8×300 mm)

Column temperature: 40° C. (thermostat)

Mobile phase: Dimethylformamide, 0.01 M lithium bromide

Flow rate: 0.8 ml/min

Standard polymer for molecular weight

calculation: Standard polyethylene glycol

Sample concentration: 0.1 mass % (DMF/LiBr solution)

Hydrate Formation and Dissociation-Controlling Agent Evaluating Apparatus

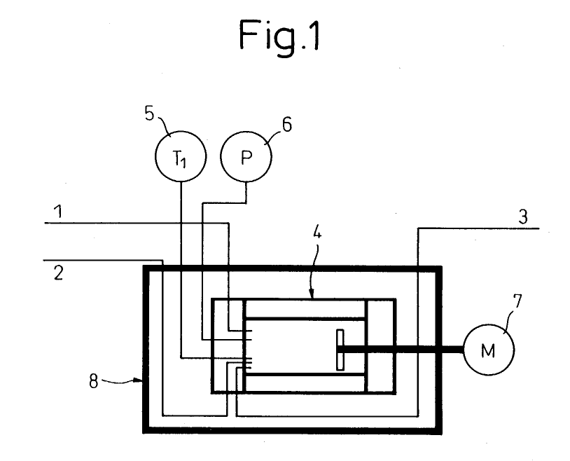

The gas hydrate formation temperature as the index of the gas hydrate formation and dissociation-controlling performance of the gas hydrate formation and dissociation-controlling agent, and the gas hydrate dissociation completion temperature as the index of the gas hydrate stabilizing performance, were measured using the apparatus shown in FIG. 1.

In this apparatus, the high-pressure reaction cell 4 has an inner volume of 100 ml and a normal pressure-resistant design for up to 20 MPa. The cell is provided with a gas introduction line 1, a liquid introduction line 2, a purge line 3, an internal cell thermometer 5, an internal cell manometer 6 and a reaction cell stirrer 7. The entire cell was housed inside a thermostat 8 to allow adjustment of the internal cell temperature by the temperature of the thermostat 8. The high-pressure reaction cell 4 is provided with 3 cm-diameter observation ports (not shown) at three locations to allow the condition in the cell to be observed.

Formation-Inhibiting Performance Evaluation Method

The gas hydrate formation-inhibiting performance was evaluated in the following manner. Specifically, a 0.5 mass % aqueous solution of the gas hydrate formation and dissociation-controlling agent to be evaluated was introduced through the liquid introduction line 2, methane gas was introduced through the gas introduction line 1 to an internal cell pressure of 10 MPa, and the internal cell temperature was set to 20° C., a temperature definitely higher than the formation equilibrium temperature of the methane hydrate at that pressure. The internal cell temperature was then slowly lowered at −4° C./hr while stirring the cell contents, and the state of methane hydrate formation in the cell at a given temperature was observed. The internal cell pressure is lowered by methane hydrate formation, while the gas hydrate formation slightly increases the internal cell temperature since it is an exothermic reaction. A lower internal cell temperature when the pressure begins to significantly fall, i.e. a lower methane hydrate formation temperature, was interpreted as greater gas hydrate formation-inhibiting performance. The value obtained by this evaluation without additives was 8.9° C.

Equilibrium Stabilization Performance Evaluation Method

The equilibrium stabilization performance was evaluated in the following manner. Specifically, after measuring the methane hydrate formation temperature in the performance evaluation described above, the thermostat temperature was lowered to 2° C. below the methane hydrate formation initiation temperature, and allowed to stand until the internal cell pressure and internal cell temperature became constant. When the internal cell temperature was then increased by 4° C./hr, the methane hydrate began to gradually dissociate inside the cell, finally separating completely into water and methane gas. A higher internal cell temperature, i.e. a higher methane hydrate dissociation completion temperature, was interpreted as greater gas hydrate equilibrium stabilization performance. The value obtained by this evaluation without additives was 14.2° C.

Kinetic Stabilization Performance Evaluation Method

The kinetic stabilization performance whereby the gas hydrate dissociation rate is kinetically reduced to delay gas hydrate dissociation was evaluated in the following manner. Specifically, after producing methane hydrate by the same procedure as for measurement of the methane hydrate formation temperature by the formation-inhibiting performance evaluation described above, the thermostat temperature was set to 2° C. and allowed to stand until the internal cell pressure and internal cell temperature became constant. Next, the methane gas in the cell was evacuated to an internal cell pressure of 2 MPa. The cell was sealed in this state, and the time until a constant internal cell pressure was reached was measured. A longer time (hereinafter referred to as “kinetic dissociation delay time”) was interpreted as greater kinetic stabilization performance for methane hydrate dissociation. The value obtained by this evaluation without additives was 40 minutes.

The method of measuring the performance of other hydrate formation and dissociation-controlling agents was based on measurement of the tetrahydrofuran (THF) hydrate formation-inhibiting performance. The measuring method was as follows.

THF Hydrate Formation-Inhibiting Performance Measuring Method

First, a THF nucleating solution is prepared as a solution of THF/ion-exchange water=1/17 (mol/mol)=1/4.25 (wt/wt). The solution is drawn up into a Pasteur pipette by capillary action and placed in a test tube, which is then immersed in dry ice/acetone and allowed to stand for 1 hour or longer to produce THF hydrate nuclei.

Next, a 3.5 mass % sodium chloride aqueous solution is prepared and the polymer solution is dissolved therein to 0.75 mass %. Ten grams of THF is added to 40 g of this solution and mixed therewith.

A 20 ml portion of the prepared aqueous THF/polymer solution mixture is placed in a test tube with an inner diameter of 21 mm and cooled at a prescribed temperature for 30 minutes.

After 30 minutes, the produced THF hydrate nuclei are placed in the test tube with a Pasteur pipette (adjusted so that the Pasteur pipette is 15 mm under the liquid surface). The time from placement in the test tube until formation of THF hydrate is measured. The THF hydrate formation is visually confirmed.

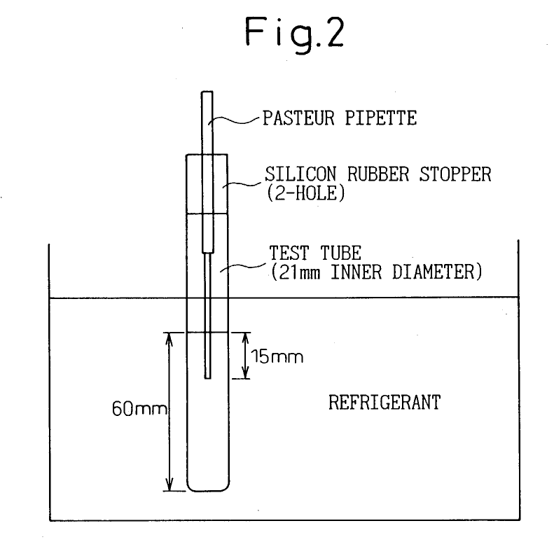

A schematic drawing of the apparatus used is shown in FIG. 2.

### EXAMPLE 1

After adding 100 g of ethylene glycol to a 1000 ml separable flask equipped with a stirrer, solvent distiller, nitrogen-introduction tube and thermocouple, the flask was placed in an oil bath and heated to 100° C. while stirring and introducing nitrogen into the gas phase section. To this there were added dropwise 40 g of ethylene glycol, 160 g of N-isopropylmethacrylamide (Mitsubishi Rayon) dissolved in 160 g of methanol, 6 g of 3-mercapto-1,2-propanediol, 1.0 g of 2,2′-azobis(2-methylbutyronitrile) (V-59, Wako Pure Chemical Industries) and 0.5 g of 1,1′-azobis(cyclohexane-1-carbonitrile) (V-40, Wako Pure Chemical Industries), over a period of 4 hours at 100° C. Polymerization was conducted while distilling the low boiling point compounds such as methanol out of the system at a polymerization solution temperature of 100° C. After completion of the dropwise addition, stirring was continued for 1 hour at 100° C. to obtain a polymer solution. The molecular weight of the polymer obtained in this manner was measured using GPC with a dimethylformamide/lithium bromide solution as the mobile phase, giving the results shown in Table 1. The obtained reaction product was diluted with distilled water to a concentration of 0.5 mass % in terms of the effective portion, and the gas hydrate formation and dissociation-controlling performance was measured. The gas hydrate controlling performance is shown in Table 1.

### EXAMPLE 2

After adding 140 g of ethylene glycol and 10 g of methanol to a 1000 ml separable flask equipped with a stirrer, cooler, nitrogen-introduction tube and thermocouple, the flask was placed in an oil bath and heated to 40° C. while stirring and adding 160 g of N-isopropylmethacrylamide (Mitsubishi Rayon) and 6 g of 3-mercapto-1,2-propanediol, after which nitrogen introduction was initiated into the gas phase portion. After then heating to 60° C., 1.0 g of 2,2′-azobis(2-methylbutyronitrile) (V-59, Wako Pure Chemical Industries) and 0.5 g of 1,1′-azobis(cyclohexane-1-carbonitrile) (V-40, Wako Pure Chemical Industries) were added with stirring followed by further heating, and the stirring was continued for 4 hours at 100° C. for polymerization. The molecular weight of the, N-isopropylmethacrylamide polymer obtained in this manner was measured using GPC with a dimethylformamide/lithium bromide solution as the mobile phase, giving the results shown in Table 1. The obtained polymer solution was diluted with distilled water to a concentration of 0.5 mass % in terms of the effective portion, and the gas hydrate formation and dissociation-controlling performance was measured. The gas hydrate controlling performance is shown in Table 1.

### EXAMPLE 3

After adding 290 g of ethylene glycol to a 1000 ml separable flask equipped with a stirrer, cooler, nitrogen-introduction tube and thermocouple, the flask was placed in an oil bath and heated to 40° C. while stirring and adding 320 g of N-isopropylmethacrylamide (Mitsubishi Rayon), 8 g of methanol and 24 g of 3-mercapto-1,2-propanediol. After then heating to 60° C., 1 g of 2,2′-azobis(2-methylbutyronitrile) (V-59, Wako Pure Chemical Industries) and 0.5 g of 1,1′-azobis(cyclohexane-1-carbonitrile) (V-40, Wako Pure Chemical Industries) were added with stirring followed by further heating, and the stirring was continued for 1 hour at 100° C. for polymerization. The reaction solution temperature due to heat of polymerization increased to a maximum of 105° C. Next, 0.5 g of 2,2′-azobis(2-methylbutyronitrile) (V-59, Wako Pure Chemical Industries), 0.25 g of 1,1′-azobis(cyclohexane-1-carbonitrile) (V-40, Wako Pure Chemical Industries) and 6 g of 3-mercapto-1,2-propanediol were added, and heating and stirring were continued for 2 hours to obtain a polymer solution.

The molecular weight of the N-isopropylmethacrylamide polymer obtained in this manner was measured using GPC with a dimethylformamide/lithium bromide solution as the mobile phase, and the mass-average molecular weight in terms of standard polyethylene glycol was found to be 3200. The effective portion of the N-isopropylmethacrylamide polymer was 50.1 mass %. The amount of residual N-isopropylmethacrylamide in the polymer solution was 5 mass %. The obtained reaction product was diluted with distilled water to a concentration of 0.5 mass % in terms of the effective portion, and the gas hydrate formation and dissociation-controlling performance was measured, giving the results shown in Table 1.

### EXAMPLE 4

After adding 290 g of ethylene glycol to a 1000 ml separable flask equipped with a stirrer, cooler, nitrogen-introduction tube and thermocouple, the flask was placed in an oil bath and heated to 40° C. while stirring and adding 320 g of N-isopropylmethacrylamide (Mitsubishi Rayon), 8 g of methanol and 24 g of 3-mercapto-1,2-propanediol. After then heating to 60° C., 2 g of 1,1′-azobis(cyclohexane-1-carbonitrile) (V-40, Wako Pure Chemical Industries) was added with stirring followed by further heating, and the stirring was continued for 4 hours at 100° C. for polymerization. The reaction solution temperature due to heat of polymerization increased to a maximum of 105° C. Next, 1 g of 1,1′-azobis(cyclohexane-1-carbonitrile) and 6 g of 3-mercapto-1,2-propanediol were further added, and heating and stirring were continued for 2 hours to obtain a polymer solution.

The molecular weight of the N-isopropylmethacrylamide polymer obtained in this manner was measured using GPC with a dimethylformamide/lithium bromide solution as the mobile phase, and the mass-average molecular weight in terms of standard polyethylene glycol was found to be 3500. The effective portion of the N-isopropylmethacrylamide polymer was 50.3 mass %. The amount of residual N-isopropylmethacrylamide in the polymer solution was 4 mass %. The obtained reaction product was diluted with distilled water to a concentration of 0.5 mass % in terms of the effective portion, and the gas hydrate formation and dissociation-controlling performance was measured, giving the results shown in Table 1.

TABLE 1

| | | | | | Hydrate | |
|---|---|---|---|---|---|---|
| | | | Mass- | Hydrate | dissociation | |
| | | | average | formation | completion | Kinetic |
| Examples and | Polymerization | | molecular | temperature | temperature | dissociation |
| Comp. Exs. | method | Initiator | weight | (° C.) | (° C.) | delay time |
| Example 1 | Dropwise | V-40/V-59 | 2,100 | 2.8 | 27.0 | 690 |
| | polymerization | | | | | |
| Example 2 | Batch charging | V-40/V-59 | 3,200 | 3.3 | 26.1 | 630 |
| Example 3 | Batch charging | V-40/V-59 | 3,200 | 3.1 | 26.2 | 650 |
| Example 4 | Batch charging | V-40 | 3,500 | 3.4 | 24.9 | 600 |
| Comp. Ex. 1 | Batch charging | V-59 | 3,400 | 4.2 | 21.0 | 490 |
| Reference* | | | | 8.9 | 14.2 | 40 |

*Results of hydrate formation and dissociation-controlling test with no additives
V-40: 1,1′-azobis(cyclohexane-1-carbonitrile)
V-59: 2,2′-azobis(2-methylbutyronitrile)

### EXAMPLE 5

After adding 240 g of ethylene glycol and 50 g of ion-exchange water to a 1000 ml separable flask equipped with a stirrer, cooler, nitrogen-introduction tube and thermocouple, the flask was placed in an oil bath and heated to 40° C. while stirring and adding 320 g of N-isopropylmethacrylamide (Mitsubishi Rayon) and 8 g of methanol. After then heating to 60° C., 1 g of 2,2′-azobis(2-methylbutyronitrile) (V-59, Wako Pure Chemical Industries), 0.5 g of 1,1′-azobis(cyclohexane-1-carbonitrile) (V-40, Wako Pure Chemical Industries) and 24 g of 3-mercapto-1,2-propanediol were added with stirring followed by further heating, and the stirring was continued for 4 hours at 100° C. for polymerization to obtain a polymer solution. The effective portion of the N-isopropylmethacrylamide polymer was 50.3 mass %. The amount of residual N-isopropylmethacrylamide in the polymer solution was 5,mass %. The molecular weight of the obtained N-isopropylmethacrylamide polymer was measured using GPC with a dimethylformamide/lithium bromide solution as the mobile phase, and the mass-average molecular weight in terms of standard polyethylene glycol was found to be 2200. The results are shown in Table 2.

### EXAMPLE 6

Polymerization was conducted in the same manner as Example 5, except for using 200 g of ethylene glycol and 90 g of water, to obtain a polymer solution. The results of evaluating the obtained polymer solution are shown in Table 2.

### Comparative Example 1

After adding 290 g of ethylene glycol to a 1000 ml separable flask equipped with a stirrer, cooler, nitrogen-introduction tube and thermocouple, the flask was placed in an oil bath and heated to 40° C. while stirring and adding 320 g of N-isopropylmethacrylamide (Mitsubishi Rayon), 8 g of methanol and 24 g of 3-mercapto-1,2-propanediol. After then heating to 60° C., 0.5 g of 2,2′-azobis(2-methylbutyronitrile) (V-59, Wako Pure Chemical Industries) was added with stirring followed by further heating, and the stirring was continued for 1 hour at 100° C. for polymerization. This was followed by further addition of 0.5 g of 2,2′-azobis(2-methylbutyronitrile) 20 minutes and 30 minutes after the initial catalyst addition. Next, 1 g of 2,2′-azobis(2-methylbutyronitrile) and 6 g of 3-mercapto-1,2-propanediol were further added, and heating and stirring were continued for 2 hours to obtain a polymer solution. The molecular weight of the N-isopropylmethacrylamide polymer obtained in this manner was measured using GPC with a dimethylformamide/lithium bromide solution as the mobile phase, and the mass-average molecular weight in terms of standard polyethylene glycol was found to be 3400. The effective portion of the obtained N-isopropylmethacrylamide polymer was 50.1 mass %. The amount of residual N-isopropylmethacrylamide in the polymer solution was 8 mass %. The obtained reaction product was diluted with distilled water to a concentration of 0.5 mass % in terms of the effective portion, and the gas hydrate formation and dissociation-controlling performance was measured, giving the results shown in Table 1.

### EXAMPLE 7

Polymerization was carried out by repeating the same procedure of Example 5, except for using 290 g of ethylene glycol and no added water, to obtain a polymer solution. The results of evaluating the obtained polymer solution are shown in Table 2.

### EXAMPLE 8

Polymerization was carried out by repeating the same procedure of Example 5, except for using 285 g of ethylene glycol and 5 g of water, to obtain a polymer solution. The results of evaluating the obtained polymer solution are shown in Table 2.

### EXAMPLE 9

Polymerization was carried out by repeating the same procedure of Example 5, except for using 90 g of ethylene glycol and 200 g of water, to obtain a polymer solution. The results of evaluating the obtained polymer solution are shown in Table 2.

TABLE 2

| | | Mass-average | Moisture | Residual monomer |
|---|---|---|---|---|
| | | molecular | content | amount |
| Example | Initiator | weight | (mass %)* | (mass %) |
| Example 5 | V-40/V-59 | 2,200 | 15.5 | 10 |
| Example 6 | V-40/V-59 | 2,500 | 28.0 | 12 |
| Example 7 | V-40/V-59 | 2,700 | 0 | 34 |
| Example 8 | V-40/V-59 | 2,400 | 1.6 | 32 |
| Example 9 | V-40/V-59 | 3,900 | 62.2 | 38 |

*Moisture content: Mass % of moisture with respect to polymer solution minus polymer effective portion
**Residual monomer amount: Mass % of residual monomer with respect to polymer effective portion
V-40: 1,1′-azobis(cyclohexane-1-carbonitrile)
V-59: 2,2′-azobis(2-methylbutyronitrile)

### EXAMPLE 10

The polymer solution obtained in Example 1 was diluted with a 3.5% aqueous sodium chloride solution to a concentration of 0.75 mass % in terms of the effective portion, and the tetrahydrofuran hydrate formation and dissociation-controlling performance was measured. The results are shown in Table 3.

### EXAMPLE 11

After adding 72 g of ethylene glycol to a 1000 ml separable flask equipped with a stirrer, solvent distiller, nitrogen-introduction tube and thermocouple, the flask was placed in an oil bath and heated to 100° C. while stirring and introducing nitrogen into the gas phase section. To this there were added dropwise 32 g of ethylene glycol, 160 g of methanol, 160 g of N-isopropylmethacrylamide (Mitsubishi Rayon) dissolved in 40 g of ion-exchange water, 6 g of 3-mercapto-1,2-propanediol, 1.0 g of 2,2′-azobis(2-methylbutyronitrile) (V-59, Wako Pure Chemical Industries), 0.5 g of 1,1′-azobis(cyclohexane-1-carbonitrile) (V-40, Wako Pure Chemical Industries) and 10 g of acetone, over a period of 4 hours at 100° C. Polymerization was conducted while distilling the low boiling point compounds such as methanol out of the system for a polymerization solution temperature of 100° C. After completion of the dropwise addition, a solution of 1.5 g of 3-mercapto-1,2-propanediol, 0.24 g of 2,2′-azobis(2-methylbutyronitrile) (V-59, Wako Pure Chemical Industries) and 0.12 g of 1,1′-azobis(cyclohexane-1-carbonitrile) (V-40, Wako Pure Chemical Industries) in 20 g of acetone and 20 g of methanol was added over a period of 1 hour. Stirring was then continued for 1 hour at 100° C. to obtain a polymer solution. The molecular weight of the polymer obtained in this manner was measured using GPC with a dimethylformamide/lithium bromide solution as the mobile phase, giving the results shown in Table 3. The obtained reaction product was diluted with a 3.5% aqueous sodium chloride solution to a concentration of 0.75 mass % in terms of the effective portion, and the tetrahydrofuran hydrate formation and dissociation-controlling performance was measured. The results are shown in Table 3.

### EXAMPLES 12-16

Polymerization was carried out by repeating the same procedure of Example 11, except for changing the initiator and chain transfer agent amounts, to obtain a polymer solution. The molecular weight of the polymer obtained in this manner was measured using GPC with a dimethylformamide/lithium bromide solution as the mobile phase, giving the results shown in Table 3. The obtained reaction product was diluted with a 3.5% aqueous sodium chloride solution to a concentration of 0.75 mass % in terms of the effective portion, and the tetrahydrofuran hydrate formation and dissociation-controlling performance was measured. The results are summarized in Table 3.

TABLE 3

| | | | | | | | | | Moles of | | | Time to |
|---|---|---|---|---|---|---|---|---|---|---|---|---|
| | | | | | Moles of | | | | TG/(moles of | Mass- | Time to | forma- |
| | | | | | TG/(moles of | | | | V-40 + moles | average | formation | tion at |
| Exam- | Polymeriza- | V-40 | V-59 | TG | V-40 + moles | V-40 | V-59 | TG | of V-59) | molecular | at −2° C. | −3° C. |
| ple | tion method | (g) | (g) | (g) | of V-59) | (g) | (g) | (g) | (g) | weight | (min) | (min) |
| Ex.10 | Dropwise | 1 | 0.5 | 6 | 8.3 | — | | — | — | 2,100 | No forma- | 13 |
| | | | | | | | | | | | tion for | |
| | | | | | | | | | | | 120 mins. | |
| Ex.11 | Dropwise | 1 | 0.5 | 6 | 8.3 | 0.24 | 0.12 | 1.5 | 8.6 | 2,700 | No forma- | 16 |
| | | | | | | | | | | | tion for | |
| | | | | | | | | | | | 120 mins. | |
| Ex.12 | Dropwise | 2 | 1 | 6 | 4.1 | 0.48 | 0.24 | 1.5 | 4.3 | 2,500 | No forma- | 10 |
| | | | | | | | | | | | tion for | |
| | | | | | | | | | | | 120 mins. | |
| Ex.13 | Dropwise | 1 | 0.5 | 12 | 16.6 | 0.24 | 0.12 | 3 | 17.3 | 1,400 | No forma- | 24 |
| | | | | | | | | | | | tion for | |
| | | | | | | | | | | | 120 mins. | |
| Ex.14 | Dropwise | 0.72 | 0.36 | 18 | 34.5 | 0.24 | 0.12 | 4.5 | 25.9 | 940 | 30 | — |
| Ex.15 | Dropwise | 2 | 1 | 3 | 2.1 | 0.48 | 0.24 | 0.7 | 2.2 | 4,200 | 25 | — |
| Ex.16 | Dropwise | 1 | 0.5 | 18 | 24.9 | 0.24 | 0.12 | 4.5 | 25.9 | 950 | 35 | — |

V-40: 1,1′-azobis(cyclohexane-1-carbonitrile)
V-59: 2,2′-azobis(2-methylbutyronitrile)
TG: 1-mercapto-2,3-propanediol
Molecular weights: V-40: 244.34, V-59: 192.26, TG: 108.16

The methane hydrate formation temperature was as low as 3.4° C. or below in Examples 1-4 compared to 4.2° C. in Comparative Example 1, thus indicating high gas hydrate formation-inhibiting performance. The methane hydrate dissociation completion temperature was high at 24.9° C. or above in Examples 1-4 compared to 21.0° C. in Comparative Example 1, indicating high equilibrium stabilization performance with respect to gas hydrates. The kinetic dissociation delay time was long at 600 minutes or longer in Examples 1-4 compared to 490 minutes in Comparative Example 1, indicating high kinetic stabilization performance for gas hydrate dissociation. Also, in Example 1, the hydrate formation temperature, dissociation completion temperature and kinetic dissociation delay time were 2.8° C., 27.0° C. and 690 minutes, respectively, which were superior to the best values of 3.1° C., 26.1° C. and 650 minutes in the other examples, thereby indicating that a polymer with higher performance had been obtained by dropwise polymerization. This tendency was also found in measurement of the THF hydrate formation-inhibiting performance, where the poorest result was 25 minutes at −2° C. for the dropwise polymerization product as compared to 5 minutes at −2° C. for the batch charging polymerization, indicating that a polymer with high performance had been obtained by dropwise polymerization. Example 4 exhibited values of 3.4° C., 24.9° C. and 600 minutes which were inferior to the poorest values of 3.3° C., 26.1° C. and 630 minutes in the other examples, thus indicating a high effect exhibited by the V-40 and V-59 combined system.

Examples 5 and 6 were carried out with the same amount of initiator and the same polymerization time as in Examples 7 to 9, but the residual monomer amounts, at 12% or lower, were much lower than the values of 32% or higher in Examples 7 to 9, indicating that adjustment of the moisture content can reduce the residual monomer amount with the same amount of initiator.

In Examples 10 to 13, measurement of the THF hydrate formation-inhibiting performance showed that no hydrates were produced even up to 120 minutes with evaluation at −2° C., thereby indicating that extremely high hydrate formation and dissociation-controlling performance is exhibited if the number of moles of the nonionic chain transfer agent for dropwise addition is 3 to 20 times the number of moles of the polymerization initiator.

The process for producing amphipathic polymers according to the present invention allows production of polymers with high hydrate formation and dissociation-controlling performance. It also allows production of polymers of low molecular weight with low residual monomer contents using the same amounts of polymerization initiators.

What is claimed is:

1. A process for producing polymers which comprises polymerizing an amphipathic monomer or copolymerizing an amphipathic monomer and another monomer which is copolymerizable therewith, wherein a polymerization solvent, a nonionic chain transfer agent and 1,1′-azobis(cyclohexane-1-carbonitrile) as a polymerization initiator are used together with said monomer.

2. The process as claimed in claim 1, wherein an azo-based nonionic polymerization initiator is also used in combination as the polymerization initiator.

3. The process as claimed in claim 1, wherein at least one type of alcohol is used as the polymerization solvent, and the polymerization system contains water at 2 to 50 mass %.

4. The process as claimed in claim 1, wherein polymerization is conducted while adding the monomer, polymerization initiator and nonionic chain transfer agent dropwise to the polymerization solvent.

5. The process as claimed in claim 4, wherein the number of moles of the nonionic chain transfer agent is 3 to 20 times the number of moles of the polymerization initiator.

6. The process as claimed in claim 1, wherein additional nonionic chain transfer agent is added after the peak temperature has been reached due to heat of polymerization.

7. The process as claimed in claim 1, wherein additional polymerization initiator is added after the peak temperature has been reached due to heat of polymerization.

8. The process as claimed in claim 1, wherein the amphipathic monomer is N-isopropylmethacrylamide.

9. The process as claimed in claim 1, wherein the nonionic chain transfer agent is 3-mercapto-1,2-propanediol.

10. Use of a polymer obtained according to any one of claims 1 to 9 as a hydrate formation and dissociation-controlling agent.
